(19) United States
(12) Patent Application Publication
(10) Pub. No.: US 2002/0033379 A1
(43) Pub. Date: Mar. 21, 2002

(54) Method for hydrophilic treatment of metal surface

(75) Inventors: Hiroki Hayashi, Chuo-ku (JP); Mitsuhiro Matsumoto, Chuo-ku (JP); Hiroyuki Iizuka, Chuo-ku (JP)

Correspondence Address: SHERMAN & SHALLOWAY, 413 North Washington Street, Alexandria, VA, 22314, US

(73) Assignee: Nihon Parkerizing Co., Ltd.

(21) Appl. No.: 09/918,444

(22) Filed: Aug. 1, 2001

(30) Foreign Application Priority Data
Aug. 2, 2000 (JP) 2000-233927

(51) Int. Cl. B44C 1/22

(52) U.S. Cl. 216/37; 216/85; 216/100; 216/103; 216/104; 216/105; 216/106; 216/107

(57) ABSTRACT

The present invention is to provide a hydrophilic treating method of the surface of metal comprising, the first process which treat the surface of metal with a chemical conversion solution to form a chemical conversion film on the metal surface while etching the metal surface and the second process which remove said film formed on the surface of metal to obtain rougher surface, and the final process which forms a hydrophilic film on the surface of metal. Desirably the surface roughness indicated by Rz after above mentioned second process is rougher than 1.5 μm.

### BACKGROUND OF THE INVENTION

1. Field of the Invention

The present invention relates to a method for hydrophilic treatment of metal surface, and more in detail, relates to a method to form a hydrophilic film, which has excellent adhesiveness and durability, on the surface of metal. 2.Description of the Prior Art

As the substantial example, a heat transferring tube used for a heat exchanger is discussed. In a case of a heat transferring tube used for a heat exchanger, for the purpose to improve the thermal conduction, it is required that both inner and outer surface of the heat transferring tube, which is made of metal, to have good affinity with water or aqueous solution of lithium bromide. That is, the hydrophilic affinity (wettability) of metal tube surface is required. For the purpose to make the surface of metal hydrophilicity, usually, methods to improve the hydrophilic affinity of metal surface by mechanical grinding or by chemical cleaning such as acid pickling (refer to Japanese Patent Laid-open publication 5-179419), or a method to form a hydrophilic film by coating a hydrophilic coating on the surface of metal tube after treated by chemical cleaning such as acid pickling (Japanese Patent Publication 4-73068) are practically used.

However, in a case when mechanical grinding method is used, fine particles of abrasive are stuck to the surface of metal after grinding and deteriorate the hydrophilic affinity of the metal surface. Further, in a case of the mechanical grinding method, the grinding is effected by the shape of the work, and when the work has a complicated shape, some times partially not-ground surface is reminded, and the purpose to grind all surface can not be accomplished. In the meanwhile, in a case of chemical cleaning method, the treatment is not effected by the shape of the work, however, after the treatment, since the surface of metal is exposed, the surface changes easily by the progress of time and the aimed hydrophilic affinity cannot be obtained. Further, when the method to coat the hydrophilic coating on the surface of metal after treated by chemical cleaning is used, since a surface with sufficient roughness cannot be formed on the metal surface by chemical cleaning such as acid pickling, adhesiveness of the hydrophilic coating to the metal surface is not sufficient and the hydrophilic coating removes by the progress of time at the actual use. And after the hydrophilic coating is removed, the sufficient hydrophilic affinity cannot be obtained.

The present invention is carried out concerning above mentioned circumstances, and the object of the present invention is to provide a method to impart an excellent hydrophilic affinity to the metal surface by forming a hydrophilic film having good adhesiveness and durability and further to provide a method to maintain good hydrophilic affinity even if the hydrophilic film is removed by the progress of time at the actual use.

### BRIEF SUMMARY OF THE INVENTION

The inventors of this invention have carried out an intensive study to develop a method to dissolve the problems that the prior arts have, and found out the following facts. That is, the inventors have found that, for the purpose to eliminate the shape dependency of metal materials, it is desirable to carry out a hydrophilic treatment by a chemical treatment and for the purpose to obtain a strong adhesiveness with hydrophilic film to be formed on the surface, it is desirable to finish the surface rougher so as to display the efficient wedge effect, further, have found that by the rougher surface profile, the hydrophilic affinity of the surface can be maintained even if the hydrophilic film is lost by peeling. Thus, the present invention is accomplished.

That is, the present invention is a hydrophilic treating method of the surface of metal comprising, the first process which treat the surface of metal with a chemical conversion solution to form a chemical conversion film on the metal surface while etching the metal surface and the second process which remove said film formed on the surface of metal to obtain rougher surface, and the final process which forms a hydrophilic film on the surface of metal. It is desirable that the surface roughness indicated by Rz of the surface of metal after said second process is rougher than 1.5 μm.

### DETAILED DESCRIPTION OF THE INVENTION

The kind of metals which can be the object of the hydrophilic treatment of this invention is not restricted, however, substantially, metal materials of iron type, zinc type, aluminum type, magnesium type, titanium type, zirconium type, copper type and nickel type can be mentioned. The present invention can be desirably applied to the alloy based on these metals. For example, in a case of iron type materials, it is possible to be applied to stainless steel. Furthermore, it is possible to be applied to the metal that is plated on the surface of other materials. Namely, in the present invention, the term of “•••type” means the concept containing the metal itself, alloys based on said metal, subjects on which said metal is plated and subjects on which alloy based on said metal is plated. For example, in the term of “iron type”, not only iron itself, but also carbon steel, iron-zinc alloy, zinc plated steel plate and steel plate plated by iron-zinc alloy are included.

For the purpose to apply the treating method of the present invention, it is desirable to remove stains, in particular, oil stains, and oxidized film from the surface of metal previously. That is, before the carrying out of the first process, it is desirable to remove oil stains by cleaning using organic solvent or alkaline degreasing agent and remove surface oxidized film by acid pickling using various kind of acids such as hydrochloric acid, sulfuric acid, nitric acid or hydrofluoric acid in accordance with the kind of metal materials. Of cause, the acid pickling of this case is not intending the etching which is the object of the first process, but intending only to remove the surface oxidized film and not necessary to form uneven shape on the surface. As mentioned above, it is very difficult to form desired uneven shape on the surface only by acid pickling.

The first process of the present invention will be illustrated more readily as follows. The first process is a process to carry out the treatment with a chemical conversion solution to form a chemical conversion film on the metal surface while etching the metal surface on the surface of metal. The meaning of the phrase of “treatment with a chemical conversion solution to form a chemical conversion film on the metal surface while etching the metal surface on the surface of metal” of this invention is illustrated as follows. That is, innumerable micro films are formed on the surface of metal by anode •cathode reaction, by the contact of the chemical etching agent to the surface of metal, and the part except parts on which film is formed is treated by chemical etching.

By the ordinary chemical etching treatment, from the microscopic viewpoint, the obtained surface of metal is characterized to have smoothed uneven shape from which sharpen edges are removed. In the meanwhile, according to the above mentioned treatment with a chemical conversion solution to form a chemical conversion film on the metal surface while etching the metal surface on the surface of metal, the surface of metal which has sharpened uneven shape can be obtained. That is, according to the treatment with a chemical conversion solution to form a chemical conversion film on the metal surface while etching the metal surface, since only the part of surface of metal on which the film is not formed is preferably etched, the concave uneven shape which has shape angle against metal surface can be formed.

The treatment with a chemical conversion solution to form a chemical conversion film on the metal surface while etching the metal surface on the surface of metal of the first process will be illustrated concretely according to the following description. The solution used to this treatment with a chemical conversion solution to form a chemical conversion film on the metal surface while etching the metal surface on the surface of metal by chemical etching is preferably selected according to the metal materials to be treated. If the metal to be surface treated is a metal selected from the group consisted of iron type, zinc type, aluminum type and copper type, the treatment with a chemical conversion solution to form a chemical conversion film on the metal surface while etching the metal surface on the surface of metal can be carried out by using aqueous solution containing at least one metal ion selected from the group consisted of zinc ion, nickel ion, cobalt ion, calcium ion and manganese ion and phosphoric ion as necessary components and whose pH is maintained in the limits from 1 to 5.

And if the metal to be surface treated is a metal selected from the group consisted of titanium type, zirconium type and aluminum type, the treatment of the surface of metal with a chemical conversion solution to form a chemical conversion film on the metal surface while etching the metal surface can be carried out by using acidic aqueous solution containing at least one ion selected from the group consisted of fluorine compound ion, phosphoric ion and alkali metal ion. Further, if the metal to be surface treated is an amphoteric metal, the treatment of the surface of metal with a chemical conversion solution to form a chemical conversion film on the metal surface while etching the metal surface can be carried out by using basic aqueous solution containing at least one heavy metal ion or heavy metallic acid ion selected from the group consisted of zinc ion, nickel ion, cobalt ion, molybdic ion, tangstate ion, chromatic ion, vanadinic ion and iron ion.

Furthermore, if the metal to be surface treated is a stainless steel type material, the treatment with a chemical conversion solution to form a chemical conversion film on the metal surface while etching the metal surface on the surface of metal can be carried out by using aqueous solution containing at least oxalate ion and fluorine ion. Still further, if the metal to be surface treated is a copper type materials, the treatment of the surface of metal with a chemical conversion solution to form a chemical conversion film on the metal surface while etching the metal surface can be carried out by using strong alkaline aqueous solution containing at least copper ion and an oxidizing agent as an necessary component.

Secondary, the second process of the present invention will be illustrated as follows. This second process is a process to remove innumerable micro films which are formed on the surface of metal at the chemical etching process, which is the above mentioned first process. At the removing of films, it is desirable to carry out the treatment removing only film on the surface of metal and not injuring the surface of metal. However, even if the surface of metal is injured by the treatment, it can be applicable by adjusting the treating conditions (time, temperature etc.) adequately.

As the method to remove only film without injuring the surface of metal, for example following methods can be mentioned. Namely, when the metal to be surface treated is an iron type material, the treating method to remove films using aqueous solution of chromatic acid or strong alkaline aqueous solution can be mentioned. When the metal to be surface treated is a copper type materials, the treating method to remove films using hydrochloric acid can be mentioned, and when the metal to be surface treated is an aluminum type materials, the treating method to remove film using nitric acid can be mentioned. In the meanwhile, it is desirable to carry out said first process and/or second process by an electrolysis method, because the conditions such as electric voltage or charging period can be voluntarily adjusted and the desired surface condition can be easily controlled. In this case, the conventional electrolysis method can be applied.

By above mentioned first process and second process, the surface of metal which is homogeneously roughened can be generated. In this case, it is desirable that the surface roughness (Rz) of metal is rougher than 1.5 μm. And, as mentioned above, on the surface of metal after treated by the first process and the second process, the concave uneven shape which has shape angle against metal surface can be formed. Although the surface roughness (Rz, Ra) of the surface obtained as mentioned above indicates almost similar numerical value to the surface of metal obtained by different methods, the obtained surface has an efficient wedge effect to the hydrophilic film to be formed subsequently. Therefore, by said method, the hydrophilic film having excellent durability and adhesiveness can be formed. Further, even if the hydrophilic films are lost from the rougher surface, said specific shape acts effectively and displays excellent hydrophilic affinity. When the surface roughness (Rz) is finer than 1.5 μm, the effect is not sufficient to the expected level. Further, by the chemical etching treatment of the present invention, since this treatment is using chemical contact with chemical agent, there is a strong point that it is not restricted by the shape of metal materials to be treated.

In the present invention, a hydrophilic film is formed on the rougher surface of metal which is roughened by said first and second process. To form a hydrophilic film, the surface is treated by a treating agent for hydrophilic film forming. The treating agent for hydrophilic film forming is not restricted, however, can be classified to an organic film (resin) forming type and inorganic film forming type. As the organic film forming type, acrylic type resin or urethane type resin can be mentioned, additionally, agents which contains silica or alumina sol can be mentioned. While, as the inorganic film forming type, so called water glass represented by water soluble alkali silicate can be mentioned. The treating solution which generate hydrophilic affinity, for example the treating solution containing titanium oxide can be used.

As a treating method by the treating agent for hydrophilic film forming, a dissolving method, a coating method and a spraying method can be mentioned, and preferably selected with accordance to the feature of the treating agent and shape of the work. By these treating method, the hydrophilic film having excellent adhesiveness and durability can be formed on the surface of metal, and can impart hydrophilic affinity (wettability) to the surface of metal. For the purpose to eliminate the corrosion of metal, before the treatment for forming hydrophilic film, the anticorrosion treatment can be carried out, in the limit not to affect the surface roughness of the surface after said second process.

### EXAMPLE

The present invention will be illustrated more readily by the Examples and Comparative Examples, however, not intended to limit the scope of claims of the present invention.

### Example 1

After the surface of stainless steel plate (SUS304) is cleaned by alkaline degreasing agent (Fine Cleaner 4360; product of Parkerizing Co., Ltd.,), dipped into 10% hydrochloric acid for 10 minutes so as to carry out acid pickling. Then, the stainless steel plate is dipped into 95° C. iron oxalate treating solution (aqueous solution containing 5 g/L of nitric acid, 1.5 g/L of hydrofluoric acid and 30 g/L oxalic acid) for 10 minutes, and the iron oxalate film of 6.5 g/m² is formed.

The stainless steel plate on the surface of which the iron oxalate film is formed is dipped into mixed acid of nitric acid-hydrofluoric acid (aqueous solution of 13% of nitric acid and 1.2% hydrofluoric acid) of room temperature for approximately 5 minutes so as to remove iron oxalate film, and rinsed by water. Then dipped into Paltop 3975 (organic type hydrophilic film forming treating agent) treating solution (4 parts of B agent is blended to 10 parts of A agent), which is a product of Nippon Parkarising Co., Ltd., for 30 seconds and dried in a circulation dryer adjusted to 150 ° C. for 10 minutes. Thus, the hydrophilic film (thickness of film is 5 μm) is formed. The surface roughness (Rz) of test piece before hydrophilic skin formation is 2.2,μm.

### Example 2

After the surface of aluminum plate (A1100) is cleaned by alkaline degreasing agent (Fine Cleaner 315; product of Parkerizing Co., Ltd.,), the aluminum plate is dipped into 3% aqueous suspension of sodium(hydro) siliconfluoride of 90 ° C. for 2 minutes, and sodium aluminumfluoride film of 11 g/m² is formed.

The aluminum plate on which sodium aluminumfluoride film is formed is dipped into 30% nitric acid aqueous solution of room temperature for 3 minutes and remove the sodium aluminumfluoride film. After rinsed by water immediately, dipped into Parlen 4526 (inorganic type hydrophilic film forming treating agent) treating solution (20% solution), which is a product of Nippon Parkarising Co., Ltd., for 30 seconds and dried in a circulation dryer adjusted to 150 ° C. for 10 minutes. Thus the hydrophilic film (thickness is 3μm) is formed. The surface roughness (Rz) of test piece before hydrophilic film formation is 4.7μm.

### Example 3

After the surface of copper plate (C1100P) is cleaned by alkaline degreasing agent (Fine Cleaner 4360; product of Parkerizing Co., Ltd.,), the copper plate is dipped into chromic acid mixture (0.5% chromate anhydride, 2% sulfuric acid) of room temperature and remove the surface oxidized film. Then, dipped into boiling copper sulfate treating solution (prepared by adding copper sulfate into nitric acid of 13 g/L conc., so as the copper ion concentration to be 3 g/L) for 10 minutes and copper oxide film of 2.6 g/m² is formed.

Said copper plate on which surface copper oxide film is formed is dipped into above mentioned chromic acid-sulfuric acid mixture for 3 minutes so as to remove copper oxide film, and rinsed with water immediately. After that, dipped into 5 times diluted treating solution of A potassium silicate (25.5 to 27.5% of SiO_{2,} 12.5 to 14.5% of K₂O), which is the product of Nippon Chemical Industry Co., Ltd., for 30 seconds and dried in a circulation dryer adjusted to 150 ° C. for 10 minutes. Thus, the hydrophilic film (thickness of film is 2 μm) is formed. The surface roughness (Rz) of the test piece before hydrophilic skin formation is 2.0μm.

### Comparative Example 1

After the surface of stainless steel plate (SUS304) is cleaned by alkaline degreasing agent (Fine Cleaner 4360; product of Parkerizing Co., Ltd.,), dipped into 10% hydrochloric acid for 10 minutes so as to carry out acid pickling, then rinsed by water. After that, the stainless steel plate is dipped into Paltop 3975 treating solution (4 parts of B agent is added to 10 parts of A agent), which is a product of Nippon Parkarising Co., Ltd., for 30 seconds and dried in a circulation dryer adjusted to 150 ° C. for 10 minutes. Thus, the hydrophilic film (thickness of film is 5 μm) is formed. The surface roughness (Rz) of test piece before hydrophilic skin formation is 0.8 μm.

### Comparative Example 2

After the surface of aluminum plate (A 1100) is cleaned by alkaline degreasing agent (Fine Cleaner 315; product of Parkerizing Co., Ltd.,), the aluminum plate is dipped into nitric acid (10% aqueous solution) of room temperature so as to carry out chemical etching, then rinsed by water immediately. After that, the aluminum plate is dipped into Parlen 4526 treating solution (20% solution), which is a product of Nippon Parkarising Co., Ltd., for 30 seconds and dried in a circulation dryer adjusted to 150 ° C. for 10 minutes. Thus the hydrophilic film (thickness is 3 μm) is formed. The surface roughness (Rz) of test piece before hydrophilic skin formation is 1.5 μm.

### Comparative Example 3

After the surface of copper plate (C1100P) is cleaned by alkaline degreasing agent (Fine Cleaner 4360; product of Parkerizing Co., Ltd.,), the copper plate is dipped into chromic acid mixture (0.5 % chromate anhydride, 2% sulfuric acid) of room temperature and remove surface oxidized film. Then, dipped into boiling copper sulfate treating solution (prepared by adding copper sulfate into nitric acid of 13 g/L conc., so as the copper ion concentration to be 3 g/L) for 10 minutes and copper oxide film of 2.6 g/m² is formed. After that, the copper plate is dipped into 5 times diluted treating solution of A potassium silicate (25.5 to 27.5% of SiO₂, 12.5 to 14.5% of K₂O), which is a product of Nippon Chemical Industry Co., Ltd., for 30 seconds without removing this copper oxide film, and dried in a circulation dryer adjusted to 150 ° C. for 10 minutes. Thus, the hydrophilic film (thickness of film is 2 μm) is formed.

### Measuring Test and the Results

\mathring{1} Initial wettability and \mathring{2} durability (resistance to water) of test pieces (stainless steel plate, aluminum plate and copper plate) obtained by above mentioned Examples and Comparative Examples are investigated. \mathring{1} Initial wettability; distilled water is dropped on the hydrophilic treated test piece and the extension of the water is observed by the naked eye. \mathring{2} durability; the hydrophilic treated test pieces are dipped into water pool in which D.I. water is circulated by 300 mL/min flow rate for 10 days, then dried up. D.I. water is dropped on said dried up test piece and the extension of the water is observed by the naked eye.

TABLE 1

| | \mathring{1} initial wettability | \mathring{2} durability |
|---|---|---|
| Example 1 | ◯ | ◯ |
| Example 2 | ◯ | ◯ |
| Example 3 | ◯ | ◯ |
| Co. Example 1 | ◯ | × |
| Co. Example 2 | ◯ | Δ |
| Co. Example 3 | ◯ | Δ |

As clearly understood from the results in Table 1, the Examples of the present invention are excellent particularly in durability. All Comparative Examples are inferior to Examples in durability, and cannot accomplish the hydrophilic affinity having good durability, which is the object of the present invention. As indicated by Comparative Example 1, it is obvious that the durability is deteriorated, if the treatment is only by acid pickling. The reason why is considered as follows, that is, because the hydrophilic film is not remained and the surface roughness is not sufficient. Further, in the case of Comparative Example 2, the appropriate uneven surface is not formed, therefore, same as to Comparative Example 1, the hydrophilic film is not remained. When compared to Comparative Example 1, since surface roughness is rougher than that of Comparative Example 1, the durability is superior to that of Comparative Example 2. However, the hydrophilic affinity of the level of the present invention cannot be obtained. Also, in a case of Comparative Example 3, the hydrophilic film is not remained. Further, the hydrophilic affinity of copper oxide is lower than the level of hydrophilic affinity of the present invention, and the object of the present invention is not accomplished by Comparative Example 3.

### Effect of the Invention

As mentioned above, the hydrophilic treating method of the present invention is characterized as follows. That is, the surface of metal is roughened by the first process which carry out the treatment of the surface of metal with a chemical conversion solution to form a chemical conversion film on the metal surface while etching the metal surface and by the second process which chemically removes said formed film and forms concave uneven shape having shape angle against metal surface. Therefore, the uneven profile of the surface of metal displays a wedge effect and consequently the hydrophilic film is superior in adhesiveness and durability. Further, the surface of metal can maintain hydrophilic affinity, even if the hydrophilic film is lost during actual use. Still further, in the present invention, since an etching process and a hydrophilic film process are set up independently, an appropriate uneven surface shape can be formed surely, and can select the hydrophilic treating agent which meets to the object and can obtain the good adhesiveness.

What is Claim

1. A hydrophilic treating method of the surface of metal comprising, the first process which treat the surface of metal with a chemical conversion solution to form a chemical conversion film on the metal surface while etching the metal surface and the second process which remove said film formed on the metal surface to obtain rougher surface, and the final process which forms a hydrophilic film on the surface of the metal.

2. The hydrophilic treating method of the surface of metal according to claim 1, wherein the first process is a process to treat the surface of a metal selected from the group consisted of iron type, zinc type, aluminum type and copper type by aqueous solution containing at least one metal ion selected from the group consisted of zinc ion, nickel ion, cobalt ion, calcium ion and manganese ion and phosphoric ion as necessary components and whose pH is maintained in the limits from 1 to 5.

3. The hydrophilic treating method of the surface of metal according to claim 1, wherein the first process is a process to treat the surface of a metal selected from the group consisted of titanium type, zirconium type and aluminum type by using acidic aqueous solution containing at least one ion selected from the group consisted of fluorine compound ion, phosphoric ion and alkali metal ion.

4. The hydrophilic treating method of the surface of metal according to claim 1, wherein the first process is a process to treat the surface of stainless steel type material by using aqueous solution containing at least oxalate ion and fluorine ion.

5. The hydrophilic treating method of the surface of metal according to claim 1, wherein the first process is a process to treat the surface of copper type materials by using strong alkaline aqueous solution containing at least copper ion and an oxidizing agent.

6. The hydrophilic treating method of the surface of metal according to any one of claim of claims 1 to 5, wherein surface roughness indicated by Rz of the surface of metal after said second process is rougher than 1.5 μm.
